(19) United States
(12) Patent Application Publication
(10) Pub. No.: US 2013/0173885 A1
(43) Pub. Date: Jul. 4, 2013

(54) Processor and Methods of Adjusting a Branch Misprediction Recovery Mode

(71) Applicants: Yasuko Watanabe, Bellevue, WA (US); Srilatha Manne, Portland, OR (US); Trivikram Krishnamurthy, Sunnyvale, CA (US); Rajani Pai, Mountain View, CA (US); Michael Schulte, Austin, TX (US)

(72) Inventors: Yasuko Watanabe, Bellevue, WA (US); Srilatha Manne, Portland, OR (US); Trivikram Krishnamurthy, Sunnyvale, CA (US); Rajani Pai, Mountain View, CA (US); Michael Schulte, Austin, TX (US)

(73) Assignee: ADVANCED MICRO DEVICES, INC., Sunnyvale, CA (US)

(21) Appl. No.: 13/341,558

(22) Filed: Dec. 30, 2011

(51) Int. Cl. G06F 9/38; G06F 9/312

(52) U.S. Cl. 712/205; 712/E09.05; 712/E09.06; 712/E09.033; 712/E09.023

(57) ABSTRACT

A processor core includes a fetch control unit for fetching instructions and placing the instructions into an instruction queue and includes a branch predictor for controlling the fetch control unit to speculatively fetch at least one instruction subsequent to an unresolved branch instruction. The processor further includes a controller configured to dispatch instructions from the instruction queue and, in response to a branch misprediction of an unresolved control instruction, to apply a selected one of a checkpointing-based recovery mode and a commit-time-based recovery mode.

### FIELD

This disclosure generally relates to processors that utilize branch prediction for preventing pipeline stalls, and more particularly, to processors that utilize a misprediction recovery technique for recovering from a branch misprediction.

### BACKGROUND

High performance computers, and even portable computers with tight power budgets, utilize branch prediction to enhance performance. Branch prediction allows the processor to speculatively fetch instructions even in the presence of unresolved control instructions. In an ideal case in which the prediction accuracy is one hundred percent, the fetch unit continuously supplies correct-path instructions to the backend processor pipeline. When a branch misprediction occurs, some form of recovery action must take place to revert to the state of a last correct-path instruction because speculatively fetched wrong-path instructions can corrupt the processor state.

Branch misprediction recovery techniques include checkpointing-based recovery techniques and commit-time-based recovery techniques. Checkpointing-based techniques involve capturing snapshots or checkpoints of the processor states at selected intervals and associating with each branch information about whether it has a checkpoint or not. Such intervals can be arbitrary, periodic, or related to the fetched instructions. For example, a checkpoint may be captured at every control instruction or at a subset of control instructions that meet certain criteria (such as hard-to-predict branch instructions). Checkpointing-based recovery techniques provide fast recovery from a misprediction because the controller can restore the processor by overwriting the current processor states with the checkpoint data. Unfortunately, storing of the checkpoint data consumes overhead due to proactive checkpointing, which wastes resources on checkpoints that are created but never used and consumes area. In particular, if a checkpoint is assigned to every outstanding (unresolved) branch, the number of checkpoints matches the number of outstanding branches in the portion of the pipeline that allows instructions to be processed out of program order. Further, the size and number of checkpoints can impact dynamic and leakage power of the processor. Additionally, the storage circuitry for storing the checkpoints consumes valuable circuit real estate. Further, overall performance of the system is sensitive to the number of checkpoints because the frontend pipeline stalls in the event of a misprediction if no checkpoints are available.

Commit-time-based recovery techniques without checkpointing consume less circuit area, but they do not recover the correct processor states as quickly as the checkpointing-based recovery technique. In an example, a non-checkpointing-based recovery technique either waits until the mispredicted control instruction commits (which could take hundreds of cycles) or rebuilds the correct state by sequentially backtracking state changes performed by instructions on the wrong-path. Hence, the recovery time depends on either the time to finish executing instructions that precede the mispredicted instruction or the number of wrong-path instructions. However, the commit-time recovery needs no extra resources or area and consumes less energy because energy is expended only upon branch mispredictions.

### SUMMARY OF EMBODIMENTS

In an embodiment, a processor core includes a fetch control unit for fetching instructions and placing the instructions into an instruction queue and includes a branch predictor for controlling the fetch control unit to speculatively fetch at least one instruction subsequent to an unresolved branch instruction. The processor further includes a controller configured to dispatch instructions from the instruction queue and, in response to a branch misprediction of an unresolved control instruction, to apply a selected one of a checkpointing-based recovery mode and a commit-time-based recovery mode.

In another embodiment, a method includes fetching instructions of an instruction stream for execution on a processor having one or more cores including an unresolved branch instruction and at least one speculative instruction. The method further includes detecting a branch misprediction of the unresolved branch instruction, and applying a selected one of a checkpointing-based recovery mode and a commit-time-based recovery mode in response to detecting the branch misprediction.

In still another embodiment, a multi-core processor includes a fetch control unit for fetching instructions and placing the instructions into an instruction queue and a branch predictor for controlling the fetch control unit to speculatively fetch instructions corresponding to an unresolved control instruction. The processor further includes a controller configured to dispatch instructions from the instruction queue, and in response to a branch misprediction of the unresolved control instruction, to apply a selected one of a checkpointing-based recovery mode and a commit-time-based recovery mode.

### BRIEF DESCRIPTION OF THE DRAWINGS

FIG. 1 is a block diagram of an embodiment of a system including a processor having a controller with branch misprediction recovery control logic.

FIG. 2 is a flow diagram of an embodiment of a method of selectively applying one of a checkpointing-based recovery mode and a commit-time-based recovery mode to recover from a branch misprediction based on an operating mode of a system.

FIG. 3 is a flow diagram of an embodiment of a method of applying a selected one of a checkpointing-based recovery mode and a commit-time-based recovery mode to recover from a branch misprediction based on a mode setting of a system.

FIG. 4 is a flow diagram of a method of dynamically adjusting a branch misprediction recovery mode based on performance parameters of the processor.

In the following description, the use of the same reference numerals in different drawings indicates similar or identical items.

### DETAILED DESCRIPTION OF ILLUSTRATIVE EMBODIMENTS

Embodiments of a processor (which may be either a single processor, such as single core of a multi-core chip, or the multi-core chip as a whole) are described below that dynamically adjust a branch misprediction recovery mode in response to varying energy and performance demands. Embodiments of the processor adjust to application and system needs, as well as phase behaviors by allowing a controller of the processor to change between a checkpointing-based recovery mode and a commit-time based recovery mode. In some instances, the controller is configured to dynamically alter a number of checkpoints, a frequency of checkpoint allocations, or any combination thereof.

In an example, the processor includes a controller configured to adjust the misprediction recovery mode to allow trade-offs in the energy, performance, and area of branch misprediction recovery. To dynamically manage the energy and performance, the controller dynamically switches its branch misprediction recovery mode between a checkpoint-based recovery mode and a commit-time based recovery mode without checkpoints. A number of different policies are provided for guiding when to switch from one recovery mode to the other, including a user-defined policy or setting, a system-defined policy, other metrics of choice, or any combination thereof. In a particular example, during a high performance mode, the use of checkpoints offers fast recovery from branch mispredictions to provide high performance. The benefits of fast recovery are more pronounced in processors with less accurate branch predictors and/or deeply pipelined processors. During a low-power mode, in this example, the processor can switch to the lower energy, and slower recovery commit-time-based recovery mode, avoiding power overhead associated with the high energy consumption of a checkpointing-based recovery mode.

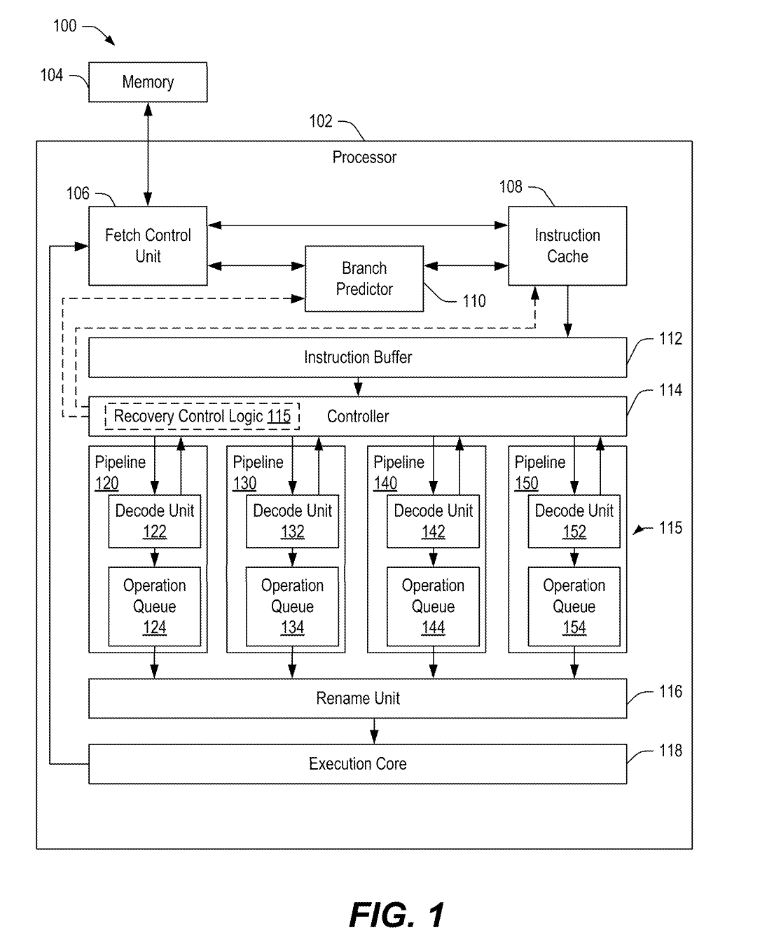

Another possible basis for changing between recovery modes includes observing changes in branch misprediction rates. During period of low misprediction rates, the controller can switch from a checkpointing-based recovery mode to a commit-time-based recovery mode based on a determination that the commit-time-based recovery mode provides sufficient performance with lower power consumption. In some instances, the controller can dynamically adjust the aggressiveness of checkpoint allocation on the fly, reducing or increasing one of the checkpoint frequency and checkpoint allotment based on the branch misprediction rates. In this instance, the controller monitors usefulness of checkpoints, instruction-path sensitive information, or clustering of mispredicted instructions, and dynamically adjusts the aggressiveness of the checkpointing based on such information. An example of a processor including a controller for dynamically switching between recovery mechanisms and/or for adjusting the aggressiveness of a checkpoint-based recovery mode is described below with respect to FIG. 1.

FIG. 1 is a block diagram of an embodiment of a system 100 including a processor 102 having a controller 114 with branch misprediction recovery control logic 115. Processor 102 is illustrative only, and is intended to depict one possible, non-limiting example. System 100 includes a memory 104, which is coupled to a fetch unit 106 of processor 102. Fetch unit 106 retrieves processor executable instructions and data from memory 104 and provides the instructions to an instruction cache 108. Instruction cache 108 includes an output coupled to an input of an instruction buffer 112, which is coupled to controller 114. Controller 114 provides instructions to one of execution pipelines 120, 130, 140, and 150. Each of the execution pipelines includes a decode unit for decoding a particular instruction and an operation queue 124 for storing each instruction before it is passed to a rename unit 116, which maps the destination address of each instruction into a physical memory address (such as a register) before providing the instruction to an execution core 118. In particular, pipeline 120 includes a decode unit 122 including an input coupled to controller 114 and an output coupled to an input of an operation queue 124, which has an output coupled to rename unit 116. Pipeline 130 includes a decode unit 132 including an input coupled to controller 114 and an output coupled to an input of an operation queue 134, which has an output coupled to rename unit 116. Pipeline 140 includes a decode unit 142 including an input coupled to controller 114 and an output coupled to an input of an operation queue 144, which has an output coupled to rename unit 116. Pipeline 150 includes a decode unit 152 including an input coupled to controller 114 and an output coupled to an input of an operation queue 154, which has an output coupled to rename unit 116.

Processor 102 also includes a branch predictor 110 that is coupled to the fetch control unit 106 and to the controller 114. Branch predictor 110 controls fetch control unit 106 to speculatively fetch instructions even in the presence of unresolved control instructions. In some instances, branch predictor 110 speculates as to which way a branch instruction will take before the branch instruction is actually resulted. In a more general sense, branch predictor 110 predicts the instructions that are most likely to be fetched after a conditional control instruction is executed and controls fetch control unit 106 to load those instructions into the instruction cache 108. Controller 114 is configured to dispatch instructions from the instruction cache 108. In response to a branch misprediction of an unresolved control instruction, recovery control logic 115 of controller 114 applies a selected one of a checkpointing-based recovery mode and a commit-time-based recovery mode to recover an architectural state of processor 102 before the mispredicted branch (i.e., to revert to the architectural states of the last correct-path instruction). In an example, recovery control logic 115 can be implemented as a state machine. Alternatively, recovery control logic 115 can be implemented as programmable microcode instructions.

In a checkpointing-based recovery mode, processor 102 makes checkpoints (snapshots of the architectural state of processor 102) at some interval of important architectural states of the processor 102 from which to recover. The interval can be arbitrary, at every control instruction, or at a subset of control instructions that meet pre-determined criteria (such as difficult-to-predict branch instructions). In the checkpointing-based recovery mode, in response to a branch misprediction of an unresolved control instruction, controller 114 retrieves the checkpoint information and overwrites the current architectural states with the checkpoint information. Further, the front end of the pipeline is flushed (discarded) and the controller redirects fetch unit 106 to fetch from the correct path. Further, wrong-path instructions in the out-of-order execution portion of the pipeline are also flushed.

In a non-checkpointing-based recovery mode, in response to a branch misprediction of an unresolved control instruction, the front end of the pipeline is flushed at the time that the branch misprediction is detected; however, controller 114 waits until the mispredicted control instruction commits before flushing the out-of-order execution portion of the pipeline and recovering the architectural state of the last correct-path instruction. This flush event flushes the wrong path instructions in the out-of-order portion of the pipeline and flushes the register mapping to remove maps to the wrong path instructions. By stalling the correct path instructions at the rename unit 116 and waiting until the misdirected branch commits, controller 114 can perform the flush operation of the out-of-order portion of the pipeline without sequential backtracking. Alternatively, controller 114 can recover the architectural state by sequentially backtracking wrong-path instructions to recover the last correct-path instruction and the architectural state of the processor 102.

In one embodiment, controller 114 selectively applies one of the checkpointing-based recovery mode and the commit-time-based recovery mode according to a selected processor mode. In a low-power mode, controller 114 applies the commit-time-based recovery mode. In a high performance mode, controller 114 applies the checkpointing-based recovery mode.

In another embodiment, controller 114 selects one of the checkpointing-based recovery mode and the commit-time-based recovery mode based on changes in branch misprediction rates. In an example, during periods with low misprediction rates, recovery control logic 115 can alter the operating mode of processor 102 to utilize the commit-time-based recovery mode, thereby avoiding unnecessary checkpointing and reducing overall power consumption. At other times, when the misprediction rate is above a threshold level, recovery control logic 115 of controller 114 utilizes the checkpointing-based recovery mode to provide improved performance.

In another embodiment, recovery control logic 115 of controller 114 employs mechanisms to dynamically adjust the aggressiveness of checkpoint allocation. In one example, recovery control logic 115 can select a checkpointing-based recovery mode as a default and, when the power level of the battery falls below a power threshold, recovery control logic 115 switches to a commit-time-based recovery mode. Alternatively, controller 114 employs the checkpointing-based recovery scheme until the controller 114 runs out of checkpoints, and then the controller 114 switches to the commit-time recovery scheme for other branches in the pipeline. In some instances, recovery control logic 115 monitors the usefulness of checkpoints, instruction-path-sensitive information, and clustering of mispredicted instructions to dynamically increase or decrease the frequency or number of checkpoints. In some instances, recovery control logic 115 can dynamically adjust the frequency or number of checkpoints in conjunction with branch predictions associated particular types of control instructions while reducing the frequency or number of checkpoints associated with other types of instructions. In adjusting the number of checkpoints, the energy consumption and area usage of the processor 102 is affected (reduced or increased depending on whether the number is reduced or increased). In response to the recovery control logic 115 utilizes commit-time recovery or a most recent checkpoint preceding the misprediction. In an alternative example, recovery control logic 115 can keep the same number of checkpoints while reducing their allocation frequency, thereby reducing dynamic power associated with allocating checkpoints. In this instance, the controller 114 can allocate checkpoints at fixed time intervals, in response to all control instructions, or selectively.

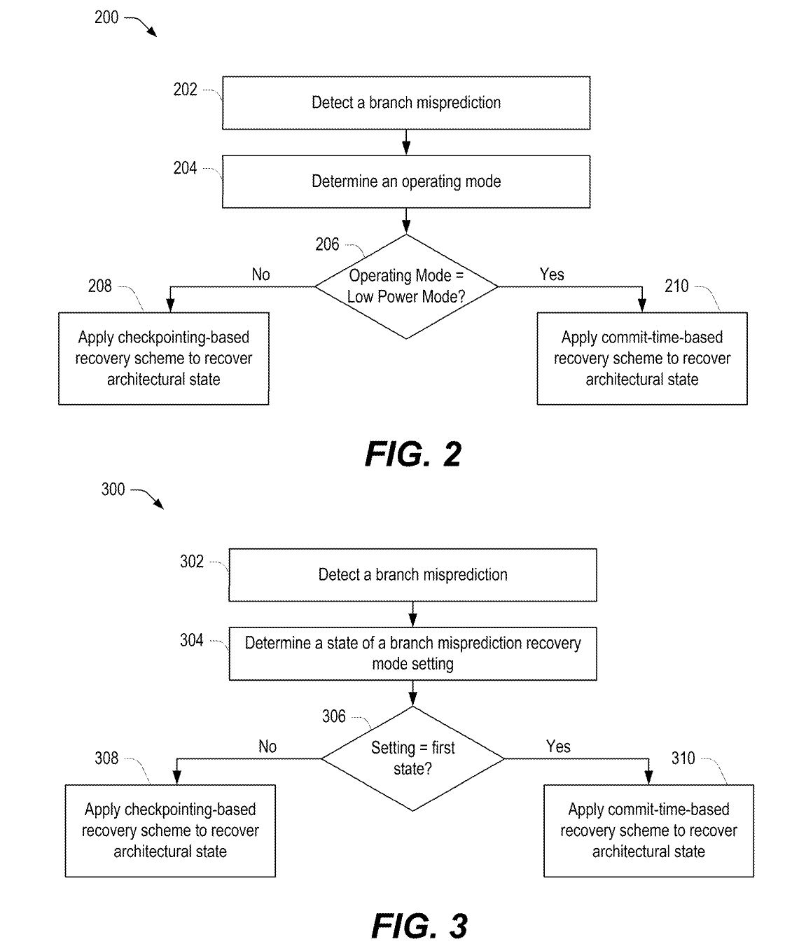

While the above-examples described different embodiments of the recovery control logic 115 configured to apply selected recovery mechanisms under difference circumstances, it should be appreciated the recovery control logic 115 can select the appropriate branch misprediction recovery mechanism and/or to adjust the selected misprediction recovery mechanism to achieve a balance between power consumption and performance. In an example, the recovery control logic 115 can select the checkpointing recovery mode based on a mode setting or operating setting of the processor, and then selectively adjusts the frequency or number of checkpoints based on one of a misprediction rate, a determined usefulness of checkpoints, instruction-path sensitive information, clustering of mispredicted instructions, or any combination thereof. In this example, recovery control logic 115 selectively adjusts an allocation of checkpoints at fixed time intervals, in response to all control instructions, in response to particular types of control instructions, or selectively based on some other metric. Recovery control logic 115 is configured to select between recovery mechanisms and to adjust recovery mechanisms on the fly, as discussed above in individual embodiments, which embodiments can be combined to provide a desired level of flexibility with respect to balancing power consumption and performance. One possible example of a method of selecting between recovery modes based on the operating mode of the processor 102 is described below with respect to FIG. 2.

FIG. 2 is a flow diagram of an embodiment of a method 200 of selectively applying one of a checkpointing-based recovery mode and a commit-time-based recovery mode to recover from a branch misprediction based on an operating mode of a system. At 202, controller 114 detects a branch misprediction. Advancing to 204, controller 114 determines an operating mode of processor 102. The operating mode can be a low power mode, a high performance mode, a pre-defined misprediction recovery mode, or another type of mode. At 206, if the operating mode of processor 102 is not a low power mode, the method 200 advances to 208 and recovery control logic 115 of controller 114 applies a checkpointing-based recovery mode to recover the architectural state of processor 102. At 206, if the operating mode of processor 102 is a low power mode, the method 200 advances to 210 and recovery control logic 115 of controller 114 applies a commit-time-based recovery mode to recover the architectural state of processor 102. In implementations whereby multiple power or performance modes are possible, such as in accordance with the Advanced Configuration and Power Interface (ACPI) specification, the decision as to whether a particular mode of the processor 102 constitutes a low-power mode for recovery mode selection can be made based on a determined threshold mode. To illustrate, the dividing line between high-performance mode and low power mode could be set between, for example, Power states (P-states) P2 and 3.

While the illustrated example determines the recovery mode based on whether the operating mode is a low-power mode, the determination can be based on whether the operating mode is a high performance mode or based on the type of application executing on the processor. Another example is described below with respect to FIG. 3.

FIG. 3 is a flow diagram of an embodiment of a method 300 of applying a selected one of a checkpointing-based recovery mode and a commit-time-based recovery mode to recover from a branch misprediction based on a mode setting of a system. At 302, controller 114 detects a branch misprediction. Advancing to 304, controller 114 determines a state of a branch misprediction recovery mode setting of processor 102. This branch misprediction recovery mode setting can be configured by operating system software, by a manufacturer, or by a user, and the selected mode setting can be used to configure a programmable bit of a register, for example. At 306, if a setting within the configuration register is not equal to a first state, the method 300 advances to 308 and recovery control logic 115 of controller 114 applies a checkpointing-based recovery mode to recover the architectural state of processor 102. At 306, if the setting within the configuration register is equal to the first state, the method 300 advances to 310 and recovery control logic 115 of controller 114 applies a commit-time-based recovery mode to recover the architectural state of processor 102.

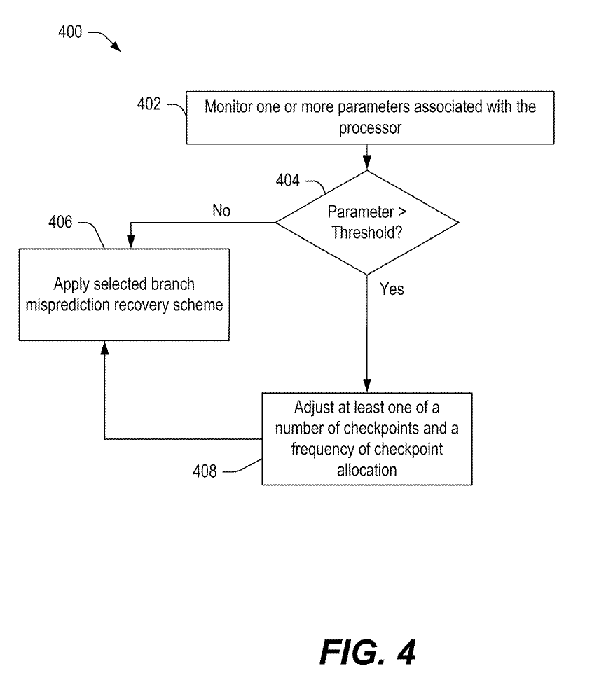

In an example, the setting can be configured by software, such as a power management application executing within the operating system of a computing system that includes the processor 102. Alternatively, the setting can be configured by the manufacturer, by an original equipment manufacturer, or by the user. In addition to selecting between branch misprediction recovery mechanisms, recovery control logic 115 can be configured to adjust checkpoints within the selected checkpointing-based recovery mode. One possible example of a method of adjusting checkpoints is described below with respect to FIG. 4.

FIG. 4 is a flow diagram of a method 400 of dynamically adjusting a branch misprediction recovery mode based on performance parameters of the processor. At 402, controller 114 monitors one or more parameters associated with the processor 102. The one or more parameters can include a branch misprediction ratio, a battery charge level, an operating mode setting, or other parameters or settings. Advancing to 404, if the parameter does not exceed a threshold, the method 400 moves to 406 and recovery control logic 115 applies the selected branch misprediction recovery mode.

Returning to 404, if the parameter exceeds the threshold, the method 400 advances to 408 and recovery control logic 115 adjusts at least one of a number of checkpoints and a frequency of checkpoint allocation. The method 400 then returns to 406 to apply the branch misprediction recovery mode and subsequently utilizes the adjusted checkpoint allocation.

In conjunction with the system, processor, and methods described above with respect to FIGS. 1-4, a processor includes a fetch control unit for fetching instructions and placing the instructions into an instruction queue and includes a branch predictor for controlling the fetch control unit to speculatively fetch at least one instruction subsequent to an unresolved branch instruction. The processor further includes a controller configured to dispatch instructions from the instruction queue and, in response to a branch misprediction of an unresolved control instruction, to apply a selected one of a checkpointing-based recovery mode and a commit-time-based recovery mode. In an example, the processor selects between modes based on a pre-configured setting, based on an operating mode of the processor, based on one or more performance parameters, or any combination thereof. Further, the processor can selectively alter the number or frequency of checkpoints and/or adjust the checkpoint trigger based on the one or more performance parameters. Additionally, the processor may be either a single processor, such as single core of a multi-core chip, or the multi-core chip as a whole.

Although the present invention has been described with reference to preferred embodiments, workers skilled in the art will recognize that changes may be made in form and detail without departing from the scope of the invention.

What is claimed is:

1. A processor core comprising:
a fetch control unit for fetching instructions and placing the instructions into an instruction queue;
a branch predictor for controlling the fetch control unit to speculatively fetch at least one instruction subsequent to an unresolved branch instruction; and
a controller configured to dispatch instructions from the instruction queue and, in response to a branch misprediction of an unresolved control instruction, to apply a selected one of a checkpointing-based recovery mode and a commit-time-based recovery mode.

2. The processor core of claim 1, further comprising:
a register coupled to the controller and configured to store at least one programmable bit to identify a misprediction recovery mode of the controller;
wherein the controller selectively applies the checkpointing-based recovery mode to recover an architectural state in response to the branch misprediction when the programmable bit has a first value; and
wherein the controller selectively applies the commit-time-based recovery mode to recover the architectural state in response to the branch misprediction when the programmable bit has a second value.

3. The processor core of claim 1, wherein the controller selectively applies the checkpointing-based recovery mode when the processor is in a high performance state and the commit-time-based recovery mode otherwise.

4. The processor core of claim 1, wherein the controller selectively applies the checkpointing-based recovery mode in a first operating mode and the commit-time-based recovery mode in a second operating mode in which power consumption of the processor is lower than the first operating mode.

5. The processor core of claim 1, wherein the controller applies the selected one of the checkpointing-based recovery mode and the commit-time-based recovery mode based on a branch misprediction rate.

6. The processor of claim 5, wherein the controller applies the checkpointing-based recovery mode when the branch misprediction rate exceeds a threshold and otherwise applies the commit-time-based recovery mode.

7. The processor core of claim 1, wherein the controller is configured to monitor one or more performance metrics and to selectively adjust a frequency of checkpoint allocations.

8. The processor core of claim 1, wherein the one or more performance metrics includes a branch misprediction rate metric.

9. The processor core of claim 1, wherein the controller is configured to monitor at least one of branch misprediction metrics and instruction-path sensitive information and to selectively adjust a total number of checkpoints stored.

10. The processor core of claim 1, wherein the controller receives a signal providing an indication of a remaining charge on a battery and applies the commit-time-based recovery mode when the remaining charge falls below a threshold.

11. The processor core of claim 1, wherein, when no checkpoint is available for the branch misprediction, in a first mode, the controller applies the commit-time-based recovery mode and, in a second mode, the controller restores an architectural state from a most recent checkpoint preceding the branch misprediction.

12. A method comprising:
fetching instructions of an instruction stream for execution on a processor having one or more cores including an unresolved branch instruction and at least one speculative instruction;
detecting a branch misprediction of the unresolved branch instruction; and
applying a selected one of a checkpointing-based recovery mode and a commit-time-based recovery mode in response to detecting the branch misprediction.

13. The method of claim 12, wherein selectively applying the one of the checkpointing-based recovery mode and the commit-time-based recovery mode comprises applying the selected one in response to at least one bit of a register.

14. The method of claim 12, wherein selectively applying the one of the checkpointing-based recovery mode and the commit-time-based recovery mode comprises:
determining an operating mode of an associated functional block;
in a first operating mode, storing checkpoints in the instruction stream and returning an architectural state of the processor to a checkpoint before the unresolved branch instruction in response to the branch misprediction; and
in a second operating mode, backtracking through the at least one speculative instruction in response to the branch misprediction.

15. The method of claim 12, wherein selectively applying the one of the checkpointing-based recovery mode and the commit-time-based recovery mode comprises:
comparing a branch misprediction rate of a branch predictor of the processor to a threshold; and
selecting the checkpointing-based recovery mode when the branch misprediction rate exceeds the threshold and otherwise selecting the commit-time-based recovery mode.

16. The method of claim 12, wherein selectively applying the one of the checkpointing-based recovery mode and the commit-time-based recovery mode comprises:
determining whether a checkpoint is available for the branch misprediction; and
when no checkpoint is available for the branch misprediction, applying the commit-time-based recovery mode to recover an architectural state or restoring the architectural state from a most recent checkpoint preceding the branch misprediction.

17. The method of claim 12, further comprising:
monitoring at least one of branch misprediction metrics and instruction-path sensitive information associated with the processor; and
adjusting one of a number of checkpoints and a frequency of checkpoint allocation in response to the at least one.

18. A multi-core processor comprising:
a fetch control unit for fetching instructions and placing the instructions into an instruction queue;
a branch predictor for controlling the fetch control unit to speculatively fetch instructions corresponding to an unresolved control instruction; and
a controller configured to dispatch instructions from the instruction queue, and in response to a branch misprediction of the unresolved control instruction, to apply a selected one of a checkpointing-based recovery mode and a commit-time-based recovery mode.

19. The multi-core processor of claim 18, wherein the controller is configured to dynamically adjust one of a total number of checkpoints stored and a frequency of checkpoint allocation based on an operating mode.

20. The multi-core processor of claim 19, wherein the controller selectively allocates checkpoints either at periodic intervals or in response to each control instruction.
